(19) United States
(12) Patent Application Publication
(10) Pub. No.: US 2026/0237265 A1
(43) Pub. Date: Aug. 13, 2026

(54) ITEM ACCESS CONTROL SYSTEMS

(71) Applicant: The Toronto-Dominion Bank, Toronto (CA)

(72) Inventors: Pooja CHUGH, Mississauga (CA); Niharika TUGNAIT, Toronto (CA); Disha KUNDRA, Toronto (CA)

(73) Assignee: The Toronto-Dominion Bank, Toronto (CA)

(21) Appl. No.: 19/049,356

(22) Filed: Feb. 10, 2025

(51) Int. Cl. G07C 9/32; B62B 5/04; G06V 20/52

(52) U.S. Cl. CPC G07C 9/32; B62B 5/0404; G06V 20/52

(57) ABSTRACT

A method and system for controlling access to items is described. In an aspect, a method includes: detecting, based on an output of a sensor, a physical selection of an item by an entity, the entity associated with a receptacle; determining, based on profile data associated with one or both of the entity and the receptacle, that the entity is not authorized to physically select the item; and in response to determining that the entity is not authorized to physically select the item, providing a control signal to an electrical component associated with the receptacle to invite deselection of the item. In some instances, a machine learning system may be used to determine that the entity is not authorized to physically select the item.

### TECHNICAL FIELD

The present application relates to item access control systems and, more particularly, to systems and computer-implemented methods to control access to an item based on a sensed condition at a physical premises.

### BACKGROUND

Item access control systems are widely used to regulate and monitor access to physical items in environments such as warehouses, retail stores, and ambient commerce platforms. In warehousing, these systems play a critical role in managing inventory, preventing unauthorized access to high-value or restricted items, and ensuring regulatory compliance. Retail environments also rely on item access control to secure age-restricted or regulated products such as alcohol, tobacco, and pharmaceuticals. These systems aim to provide security and accountability while maintaining operational efficiency. However, as access control requirements evolve in increasingly dynamic and automated environments, existing technologies face significant challenges that limit their applicability and effectiveness.

Traditional access control technologies, such as RFID and barcode systems, have been used for inventory management and product tracking. While these systems are effective for monitoring item movement, they exhibit drawbacks when applied to environments requiring secure and user-specific access control. RFID and barcode systems are designed to associate tags with items rather than individual users, making it difficult to enforce user-specific restrictions. Security concerns also arise, as RFID tags can be cloned or tampered with, and barcodes lack encryption or authentication measures. These limitations are compounded by high implementation costs for RFID infrastructure, which further restrict their utility in large-scale operations.

The challenges of item access control are particularly pronounced in ambient commerce environments, such as those employed by checkout-free retail platforms. These systems rely on advanced technologies such as computer vision and machine learning to track items as customers move through the store. However, integrating secure access control for restricted items within such systems presents unique difficulties. Identity verification to enforce age restrictions or regulatory compliance is often incompatible with the frictionless nature of ambient commerce.

### BRIEF DESCRIPTION OF THE DRAWINGS

Embodiments are described in detail below, with reference to the following drawings:

FIG. 1 is a plan view of an item access control system at a premises illustrating an operating environment of an example embodiment;

FIG. 2 is a schematic operation diagram illustrating an operating environment;

FIG. 3 is a high-level schematic diagram of an example computer device;

FIG. 4 shows a simplified organization of software components stored in a memory of the example computer device of FIG. 3;

FIG. 5 is a flowchart showing operations performed by a computer system in sending a control signal to the receptacle;

FIG. 6 is a flowchart showing operations performed by a computer system in sending a control signal to the receptacle;

FIG. 7 is a flowchart showing operations performed by a computer system in sending a control signal to the receptacle; and

FIG. 8 is a flowchart showing operations performed by a computer system in sending a control signal to the receptacle.

Like reference numerals are used in the drawings to denote like elements and features.

### DETAILED DESCRIPTION OF VARIOUS EMBODIMENTS

According to an aspect there is provided a method for controlling access to items. The method may include: detecting, based on an output of a sensor, a physical selection of an item by an entity, the entity associated with a receptacle; determining, based on profile data associated with one or both of the entity and the receptacle, that the entity is not authorized to physically select the item; and in response to determining that the entity is not authorized to physically select the item, providing a control signal to an electrical component associated with the receptacle to invite deselection of the item.

In at least some implementations, the receptacle may be a cart having a wheel associated with a lock. The control signal causes the lock to be engaged to prevent rotation of the wheel.

In at least some implementations, the method may include: identifying the entity based on an output of the sensor; and obtaining at least a portion of the profile data for the identified entity.

In at least some implementations, the method may include: identifying the item based on an output of the sensor; and determining that the identified item is a restricted item. Determining that the entity is not authorized to physically select the item may include determining that the entity is not authorized for restricted items.

In at least some implementations, the method may include: identifying the item based on an output of the sensor; and identifying a category of the item. Determining that the entity is not authorized to physically select the item may include determining that the entity is not authorized for accessing items having the identified category of the item.

In at least some implementations, the method may include identifying a parameter associated with the entity from the profile data. Determining that the entity is not authorized to physically select the item may include determining, based on the parameter and the category of the item, that the entity is not authorized to physically select the item.

In some implementations, the parameter is one or more of a role identifier and an age identifier.

In some implementations, the control signal may cause an output device on the receptacle to generate an output indicating that an unauthorized item has been selected.

In some implementations, the output device includes one or more of a light, an audible alarm, and a display.

In at least some implementations, the control signal may cause an output device on the receptacle to generate a signal that triggers a lock on an access control gate to prevent the receptacle from passing through the access control gate.

In at least some implementations, detecting, based on an output of the sensor, a physical selection of an item by an entity may include determining that the item has been added to the receptacle based on the output of the sensor.

In another aspect, there is provided an item access control system. The item access control system may include a sensor. The item access control system may include a processor in communication with the sensor. The item access control system may include a memory coupled to the processor. The memory may store processor-executable instructions which, when executed, cause the processor to perform a method described herein. For example, the instructions may cause the processor to: detect, based on an output of the sensor, a physical selection of an item by an entity, the entity associated with a receptacle; determine, based on profile data associated with one or both of the entity and the receptacle, that the entity is not authorized to physically select the item; and in response to determining that the entity is not authorized to physically select the item, provide a control signal to an electrical component associated with the receptacle to invite deselection of the item.

In at least some implementations, the item access control system may include the receptacle. The receptacle may have a wheel associated with a lock.

In another aspect, there is provided a computer-readable storage medium. The computer-readable storage medium may be a non-transitory computer-readable storage medium. The computer-readable storage medium may have stored thereon instructions which, when executed, configure a processor and/or a computer system to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

Systems and methods for providing identity data to remote computer systems using a payment network are described below.

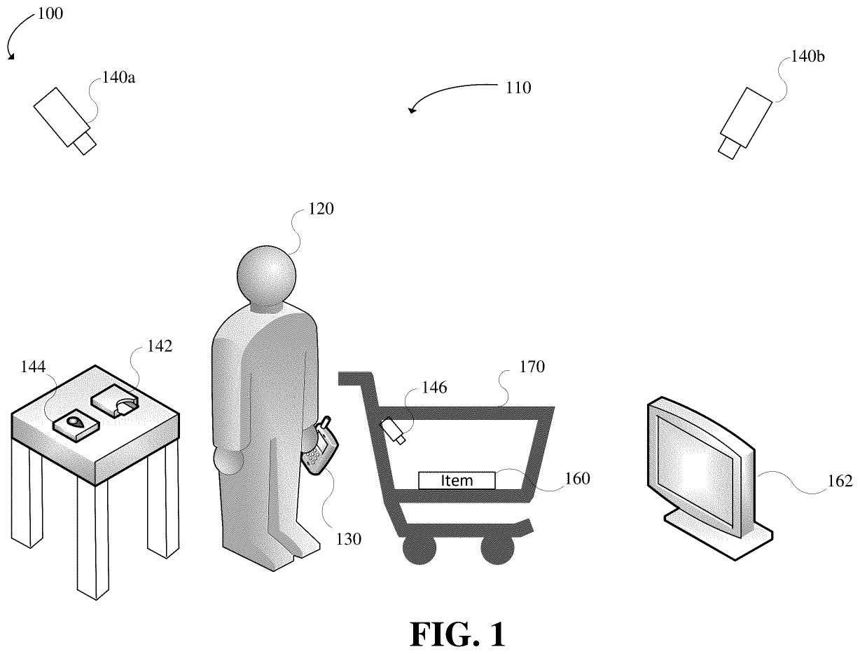

FIG. 1 is a plan view of an item access control system 100 at a physical premises. The physical premises may be a warehouse, in some implementations. The physical premises may be a distribution center, in some implementations. In the illustrated implementation, a premises 110 is provided, which is a retail environment. The premises 110 may be a merchant location such as a store. The store may be a bricks-and-mortar establishment at which a customer may physically attend to shop. By way of example, the store may be or include any one or more of a grocery store, a department store, a clothing store, a thrift shop, a sporting goods store, a big box store, a pet store, a discount store, a warehouse store, a convenience store, or a store of another type. The premises may be of another type in other implementations.

The item access control system 100 may be referred to as a cashier-less checkout system, an ambient checkout system, a “just-walk-out” system or “grab and go” system. The item access control system 100 includes one or more sensors which are used by the item access control system to identify one or more items 160, 162 that are sold at the premises 110 and that are being purchased by an entity 120 such as a customer who is on site at the premises 110.

The items may be or include any products or items. By way of example, the items 160, 162 that are available for selection via the item access control system 100 may be or include groceries, electronic goods, sporting goods, accessories, clothing, or goods of another type. One or more of the items may be a restricted item, such as an age-restricted item. By way of example, the age-restricted item may be a tobacco item such as cigarettes or chewing tobacco, a lottery item such as a lottery ticket, 50/50 ticket or scratch ticket, an alcohol product such as beer, wine or spirits, or a cannabis product such as a smokeable cannabis product, edible cannabis product, or an oil.

Restricted products may also be or include other types of restricted products. For example, any product that is not available to all customers may be a restricted product (which may also be referred to herein as a restricted item) for the purpose of this document. In some implementations, a restricted product may be a product that is a limited quantity product and which a merchant has elected to restrict the sale to only customers satisfying defined criteria. In another example, a restricted product may be a pharmaceutical.

The item access control system 100 may include various sensors. One or more of the sensors may be on site at the premises 110. The sensors may generate respective sensor outputs which are used by the item access control system 100 to facilitate item access and control. For example, the sensors may be or include one or more cameras 140a, 140b. The cameras may be located at various regions throughout the premises 110. In some implementations, the cameras 140a, 140b are part of a camera array or camera grid. The camera array or grid may provide complete or near complete coverage of all areas of the item access control system 100 and the cameras may be configured to provide some overlap in camera coverage. In some implementations, each of the cameras may include multiple image sensors or the cameras may be configured in multiples such as pairs to enable the item access control system 100 to determine and evaluate depth information as part of its analysis.

The sensors may include a receptacle contents detector 146. The receptacle contents detector 146 may be provided on the particular receptacle 170 or may associated with a particular receptacle 170. The particular receptacle 170 is a container or other receptacle which may be used for holding or transporting goods while shopping. The particular receptacle 170 may, for example, be a shopping cart, shopping basket, shopping bag, or shopping bin.

The receptacle contents detectors 146 may be or include any one or more of: a camera, a barcode reader, a quick response (QR) code reader, a wireless tag reader such as a radio frequency identifier (RFID) reader or a sensor of another type.

In some implementations, one or more of the items that may be tracked by the item access control system 100 may include a physical feature which facilitates identification of that item by one of the sensors. By way of example, the items may include a barcode which may be scanned by a barcode reader or camera, a QR code which may be scanned by a QR code reader or scanner, and/or a wireless tag such as an RFID tag.

The sensors included in the item access control system 100 may include other types of sensors and readers including, for example, a biometric reader 144 and/or a token reader 142. The biometric reader 144 and/or the token reader 142 may be identity sensors. Identity sensors are sensors that are used to verify the identity of an entity 120. That is, identity sensors may be used to associate an entity 120 on or in the premises 110 with a profile or account.

The biometric reader 144 may be or include a fingerprint sensor, a facial recognition sensor, a retina scanner, or a sensor of another type. The token reader 142 may be a physical card reader such as a payment card reader including a credit card reader or debit card reader. In some implementations, the token reader 142 may be or include a near field communication (NFC) reader. The token reader 142 may be configured, in some implementations, to wirelessly read a token which may be stored on an electronic device 130 associated with an entity 120 or which may be stored on a physical card.

The sensors included in the item access control system 100 may also include a microphone. The microphone may be used, for example, to verify the identity of an entity using a voiceprint. That is, the microphone may be used as an identity sensor.

The sensors included in the item access control system 100 may be or include a gaze detection sensor. The gaze detection sensor may be or include one or more cameras. The gaze detection sensor may be an eye gaze detection sensor. The gaze detection sensor may be used to identify at item that the entity 120 is currently looking at. The gaze detection sensor may detect where the entity 120 is looking by identifying a portion of a premises 110 being looked at from an angular direction of a head and/or eyes. In some implementations, the gaze detection sensor may be configured to identify a gaze vector and an item may be identified if it is in a direction associated with the gaze vector.

The item access control system 100 may be configured to detect the identity of an entity 120 and/or items 160, 162 that are being purchased using any one of a number of techniques. For example, in some implementations, identity may be detected using an identity sensor. For example, the biometric reader 144 and/or token reader 142 and/or one or more of the cameras 140a, 140b may be used to determine identity of an entity when the entity enters the premises 110. By way of example, in some implementations, upon entering the premises, the entity 120 may tap their electronic device at a token reader 142 which may then read a token from the electronic device which uniquely identifies the customer. In some implementations, multiple authentication techniques may be used to verify the identity of the customer. For example, the item access control system may use two or more of: facial recognition; token acquisition and verification; retinal scanning; fingerprint scanning; and voiceprint scanning.

Further, in some implementations, identity of an entity 120 may be determined or verified using a shared secret such as a personal identification number (PIN) or secret code or phrase. The item access control system 100 may include an input device for receiving input of the shared secret from an entity 120.

In some implementations, the item access control system 100 may include or operate in cooperation with an electronic device 130 associated with an entity 120. The electronic device 130 may be a portable electronic device such as a smartphone, smartwatch or other wearable electronic device. The electronic device 130 may, in some implementations, connect with the item access control system 100 when it is within a geolocation or geofence associated with the item access control system 100. For example, when the electronic device 130 is at premises, it may connect with the item access control system 100. Such communication may be performed via a long or short range communication protocol. In some implementations, the electronic device 130 may have an application stored thereon which is configured to enable the electronic device 130 to communicate with the item access control system 100.

In at least some implementations, the electronic device 130 may be used to identity an entity 120. For example, the electronic device 130 may share its location (as determined from a location subsystem such as a GPS subsystem) with the item access control system 100. The item access control system 100 may determine that a particular entity 120 is on site at the premises when the location of that entity's electronic device is within a geofence defined for the premises. Additionally or alternatively, in some implementations the electronic device 130 may connect to the item access control system 100 via a short range communication protocol such as NFC, Bluetooth™, WiFi, or a short range communication protocol of another type. In such implementations, the item access control system may determine that a particular entity 120 is on site at the premises when the location of that entity's electronic device is in communication range of a short-range communication system associated with the premises.

In some implementations, the item access control system 100 may use a biometric sensor associated with an entity's electronic device to further verify that a particular entity 120 is at the premises. For example, the item access control system may, when the electronic device is determined to be on site, cause the electronic device to prompt the entity for input of a shared secret or a biometric such as a fingerprint. In this way, the item access control system determines that the electronic device is on site and is being used by a particular entity 120. This may, for example, prevent a fraudster from circumventing the item access control system by stealing another person's electronic device.

The electronic device 130 associated with an entity 120 may be used for other purposes instead of or in addition to identification and customer detection. For example, the electronic device 130 may include an output interface such as a display screen or speaker and the output interface may be used for outputting notifications generated by the item access control system or by another system associated with the item access control system.

In some implementations, the item access control system 100 may perform a computer operation in response to detecting selection of an item by an unauthorized entity. For example, the item access control system 100 may output a notification on an electronic device 130 associated with an entity or may output notifications on an electronic device associated with an in-store representative. In some implementations, the item access control system 100 may control an access control gate, such as an electrically-controlled exit prevention device, or it may control a receptacle being used by the entity. The electrically-controlled exit prevention device may be associated with an exit for the premises and may be controlled as a direct result of a determination that an entity has selected an item that they are not authorized to select. The access control gate may be, for example, an electrically controlled turnstile. In another example, the access control gate may be a door, which may be selectively locked, opened and/or closed based on a determination of whether an entity who is about to pass through the door has selected an unauthorized item.

Selection of an item may be detected based on the output of one or more of the sensors. By way of example, selection may be detected when the item access control system determines, based on the output of a sensor such as a camera 140a, 140b, that an entity has dwelled within a geofence associated with a first item. By way of further example, selection of an item may be detected when the item access control system determines, based on the output of a sensor such as a receptacle contents detector 146, that the item has been added to a shopping receptacle. By way of further example, selection of an item may be detected based on gaze. For example, when the item access control system determines that the entity is looking at the item, which may be determined from the output of a gaze detection sensor, it may determine that the customer has selected the item.

The particular receptacle 170 may include an electrical component that may be controlled to invite deselection of a selected item. For example, the electrical component may be an output device such as a display, a light, a speaker and/or an alarm. The display may also be referred to herein as a display screen. When an item access control system 100 determines that an unauthorized item has been selected and/or added to the particular receptacle 170, it may cause the display or speaker to output a message indicating that the item should be removed. In some implementations, when an item access control system 100 determines that an unauthorized item has been selected and/or added to the particular receptacle 170, it may cause a speaker or alarm to generate an audible alarm. In some implementations, when an item access control system 100 determines that an unauthorized item has been selected and/or added to the particular receptacle 170, it may activate the light so that the light visually indicates that the particular receptacle is carrying an unauthorized item.

In some implementations, the electrical component may be or include a lockable feature. For example, the receptacle may be a cart that has a wheel associated with a lock. When the item access control system 100 determines that an unauthorized item has been added to the particular receptacle 170, it may cause the lock to be engaged to prevent rotation of the wheel.

In another example, the particular receptacle 170 may have another type of electrical component that may be controlled to invite deselection of a selected item. For example, in one implementation, the particular receptacle may include a beacon that may be activated to emit a wireless signal that prevents the receptacle from travelling through a gate or access point. For example, the beacon may emit a non-audible signal to a reader associated with the gate or access point. When an unauthorized item has been added to the particular receptacle 170, the beacon may be controlled to emit a signal that instructs the gate or access point to remain closed to prevent the receptacle from travelling therethrough. For example, automatic doors may be prevented from opening when the receptacle is near such doors and includes an unauthorised item.

In another example, the beacon may cause an audible and/or visual alarm to be activated when the particular receptacle 170 containing the unauthorized item is brought near a location associated with the alarm. That is, when the beacon is controlled to emit a signal that indicates, to the alarm, that the receptacle has an unauthorized item, the alarm may be activated.

In a further example, the particular receptacle 170 may include an electrical component that inhibits or prevents easy movement of the particular receptacle 170. This electrical component may be, for example, a vibratory device and/or a steering inhibitor device. Such devices may be activated by the access control system 100 when it determines that an unauthorized item has been added to the particular receptacle 170. The vibratory device may cause the receptacle to vibrate or shake so that it is difficult or uncomfortable to steer or move or carry. A steering inhibitor device may prevent easy movement of the particular receptacle 170 when the receptacle has an unauthorized item. For example, a wheel may be turned to the side and, in some implementations, may be locked in such position to prevent easy steering.

In yet a further example, the particular receptacle 170 may include an electrical component that causes the particular receptacle 170 to move. This electrical component may, for example, include a drive unit. The drive unit may be controlled by the access control system 100 to either prevent movement of the receptacle or to automatically navigate the receptacle away from its user. The drive unit may include, for example, a motor. The motor may be locked when the receptacle includes an unauthorized item or the motor may be activated to cause the receptacle to navigate to a particular location. For example, the receptacle may be moved to an area associated with a supervisor or manager.

FIG. 1 illustrates an access control system 100 that may be deployed at an ambient commerce premises. This access control system 100 may be deployed at other types of premises. For example, in one implementation, an item access control system 100 may be deployed at a warehouse, an industrial premises, or a distribution, shipping or fulfillment center. For example, the item access control system 100 may be deployed to prevent a worker from obtaining items that are not associated with an order that they are fulfilling and/or may be deployed to prevent a worker from obtaining high-value or restricted items without proper authorization or permissions. In another example, it may be that only a certain type of employee is authorized to access some items, and the item access control system 100 may help prevent other types of employees from accessing such items. By way of example, an electrician may be permitted to access electrical supplies, such as breakers and wire, but not plumbing supplies, such as valves. The item access control system 100 may help enforce such restrictions.

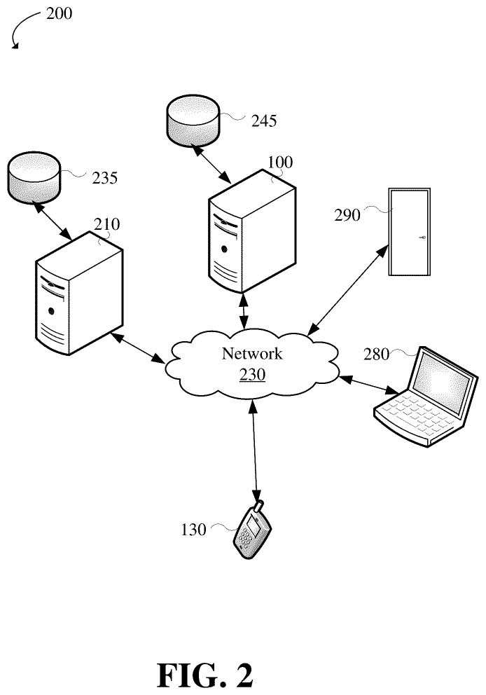

FIG. 2 is a schematic operation diagram illustrating an operating environment of an example embodiment. FIG. 2 illustrates a system 200 which may be or include an item access control system 100. The item access control system 100 may be of the type described above with reference to FIG. 1, or a variation thereof. The item access control system 100 may be or include a computer system. The computer system may be coupled with one or more sensors, as described with reference to FIG. 1 and may receive sensor output from such sensors.

The system 200 may also include an electronic device 130. The electronic device 130 may be as described above with reference to FIG. 1. For example, the electronic device 130 may be associated with an entity, such as a customer. The electronic device 130 may also be a computer system.

The electronic device 130 may be in communication with the item access control system 100. Such communication may be via a direct connection or it may be an indirect connection. An indirect connection may be a connection that relies upon other intermediary computers or systems to relay messages. For example, as illustrated in FIG. 2, the item access control system 100 and the electronic device 130 may be coupled to and communicate with one another via a network 230. The network 230 may be of various types. The network 230 may be a computer network. In some embodiments, the computer network may be an internetwork and may be formed of one or more interconnected computer networks. For example, the computer network may be or may include an Ethernet network, an asynchronous transfer mode (ATM) network, a wireless network, a telecommunications network or the like.

In some implementations, at least some communications between the electronic device 130 and the item access control system 100 may occur over a direct connection. A direct connection may be a local communication method which may not require a network. For example, example direct connections include NFC, WiFi, and Bluetooth.

The item access control system 100 may be an identification server 210, may be associated with an identification server 210 and/or may include an identification server 210. The identification server 210 may track, manage profile data for a plurality of entities. The profile data may include various types of data and may associate such data with particular entities. For example, the profile data associated with a particular entity may include one ore more of: fingerprint data, voiceprint data, facial profile data, one or more credentials such as a password, username and/or PIN, a name, contact information, and/or one or more other parameters associated with that entity. In some implementations, the other parameters associated with the entity may include an identifier. For example, the other parameter(s) may identify one or more of: a job associated with the entity, a role associated with the entity, a title associated with the entity, access rights associated with the entity, an age associated with the entity, an employer associated with the entity, or another characteristic of the entity. Put differently, the other parameter(s) may include one or more of a job identifier, a role identifier, a title identifier, an age identifier, an employer identifier, an access rights identifier or a characteristic identifier of another type.

A job identifier may indicate a job or a category of job that is performed by the entity. A role identifier may indicate a role or function that is performed by the entity. A title identifier may indicate a title such as a job title associated with the entity. An age identifier is an indicator of an entity associated with the entity, such as an age or a date of birth. An employer identifier may include, for example, an indicator of an employer of the entity. An access rights identifier may be an indicator of one or more access rights associated with the entity. By way of example, the access rights identifier may indicate a type of item that the entity is, or is not, permitted to access.

The item access control system 100 and/or a system associated with the item access control system 100 may map one or more parameters to authorization data for one or more items. The authorization data may indicate whether entities with an associated parameter are permitted to select and/or otherwise engage with particular items. In some implementations, a parameter may be mapped to a category of items and the mapping may indicate that entities associated with the parameter are (or in the alternate case, are not) permitted to select and/or otherwise engage with items in that category.

For example, as shown in FIG. 2, the identification server 210 may be coupled to a database 235. The database 235 be provided in secure storage. The secure storage may be provided internally within the identification server 210 or externally. The secure storage may, for example, be provided remotely from the identification server 210. In some embodiments, the secure storage may include one or more data centers. The data centers may, for example, store data with bank-grade security. The database 235 may, in some implementations, be coupled with or provided by another system apart from an identification server 210.

The database 235 may include account data for a plurality of accounts associated with a plurality of entities. For example, the database 235 may include records for a plurality of accounts.

The database 235 may also include identity verification data for entities having accounts in the database 235. The identity verification data may be or include a shared secret and/or biometric data such as a fingerprint, voiceprint and/or facial profile data. In at least some implementations, the identification server 210 may share at least some of the identity verification data with the item access control system 100 to assist with verifying identity of an entity at an premises 110. In other implementations, rather than share the identity verification data itself, the identification server 210 may, instead, perform identity verification for the item access control system and may confirm to the item access control system the identity of an entity.

The identification server 210 may be or include a computer system. The identification server 210 may be in communication with the item access control system 100. In the illustrated example, the identification server 210 is in communication with the item access control system 100 via the network 230.

As illustrated in FIG. 2, the item access control system 100 may also include or be connected to a datastore 245 such as a database. The datastore 245 may be or include an inventory tracking data store. In some implementations, the datastore 245 may include product or item data for one or more items that are physically present in premises 110. By way of example, the datastore 245 may include one or more parameters associated with items available at the premises 110. Such parameters may be referred to as item parameters. Example item parameters may be or may include a value parameter and/or a class parameter. A value parameter may be an indicator of a cost or price of an item. Put differently, the value parameter for an item may represent an amount of resources required to transfer ownership of the item to an entity. The value parameter may, in some implementations, be expressed in units of currency, such as in dollars, Euros, Francs, etc.

A class parameter may define a category or classification that an item belongs to and it may also be referred to as a category parameter. The category may represent a type of the item. By way of example, example categories may include any one or a combination of: consumer electronics, televisions, sporting goods, bicycles, financeable products, clothing, grocery items, etc.

In some instances, a particular item may be associated with multiple class parameters. By way of example, an item may be associated with a broad class parameter that defines a broad category of the item (e.g., consumer electronic) and a narrow class parameter that defines a narrow category of the item (e.g., television). In some implementations, the class parameter(s) for an item may be or include a binary class parameter. A binary class parameter is a class parameter that operates as a flag which defines whether the item is or is not a particular type of good associated with that class parameter. By way of example, a binary class parameter may indicate whether an item is financeable. In some implementations, a financeable item may be an item that is available for purchase using a buy now pay later feature.

The class parameter(s) for an item may also be or include a brand parameter. A brand parameter indicates a brand associated with the item. The brand may be a manufacturer of the item. The brand may be a brand that is reflected on packaging associated with the item.

The product data in the datastore 245 may include restriction data. The restriction data may identify at least one item for which selection is restricted. That is, it may identify items that are restricted items. The restriction data, in some implementations, includes binary restriction data. Binary restriction data operates as a flag which defines whether the item is or is not restricted. The restriction data may also be or include non-binary restriction data. The non-binary restriction data may, for example, define a nature of a restriction. By way of example, in some implementations, a particular item may be an age-restricted item. In such implementations, the restriction data may specify a requisite age for the item. The requisite age may be a legal minimum age required for purchase of the product in a jurisdiction associated with the item access control system 100. In other implementations, an item may be restricted on another basis. By way of example, it may be that the item is only available for purchase if a customer resides in a certain jurisdiction. By way of example, some products may not be available to purchase for out-of-jurisdiction purchasers. By way of further example, some products may only be available for purchase through a promotion and it may be that a customer needs to have a particular credit card or loyalty program or other service or subscription in order to purchase the item. Restriction data may define any one or more restrictions of the type defined above or elsewhere in this document.

The datastore 245 or another datastore may also include item identification data. The item identification data may be data that is used by the item access control system to identify an item in the premises. By way of example, in a system that relies upon a code such as a barcode or QR code for identification of items, the item identification data may include a representation of the code for a particular item. By way of further example, in a system which relies upon packaging identification, the item identification data may include information about the packaging of an item. By way of further example, in a system that relies upon in-store placement information to identify items, the item identification data may include information defining a location within the premises at which a particular item is located. By way of example, the in-store placement information may specify an aisle number, region number, shelf number, etc. and such numbers (or other identifiers) may be known to the item access control system so that the item access control system is able to identify the particular items available at various regions of the premises.

By way of further example, in a system which relies upon a tag such as an RFID tag, the item identification data may specify a number or other identifier associated with the tag.

The item access control system 100 may also include or be connected to an electronic device 280 associated with an in-store operator. The in-store operator may be an employee of a merchant operating the premises, for example. The electronic device 280 associated with the in-store operator may be of a type that is the same or similar to the electronic device 130 associated with the entity. By way of example, the electronic device 280 may be a laptop or desktop computer, a mobile computing device such as a smartphone, a smart watch or other wearable or an electronic device of another type. The electronic device 280 associated with the in-store operator may communicate with the item access control system 100 by way of a network 230.

The item access control system 100 may also include or be connected to an access control gate, such as an electrically controlled exit prevention device 290. For example, the item access control system 100 may include or be connected to as an electrically controlled gate or door associated with an exit for the premises. The electrically controlled exit prevention device 290 may be controlled to prevent the entity from leaving the premises with an item when the entity is unauthorized to select the item. In some implementations, the electrically controlled exit prevention device 290 may be or include an electrically controlled lock. In some implementations, the electrically controlled exit prevention device 290 may be or include an automatic door which may be controlled to disable opening of the door to prevent exit by an entity. In some implementations, the automatic door may be controlled to enable opening of the door to allow exit by an entity.

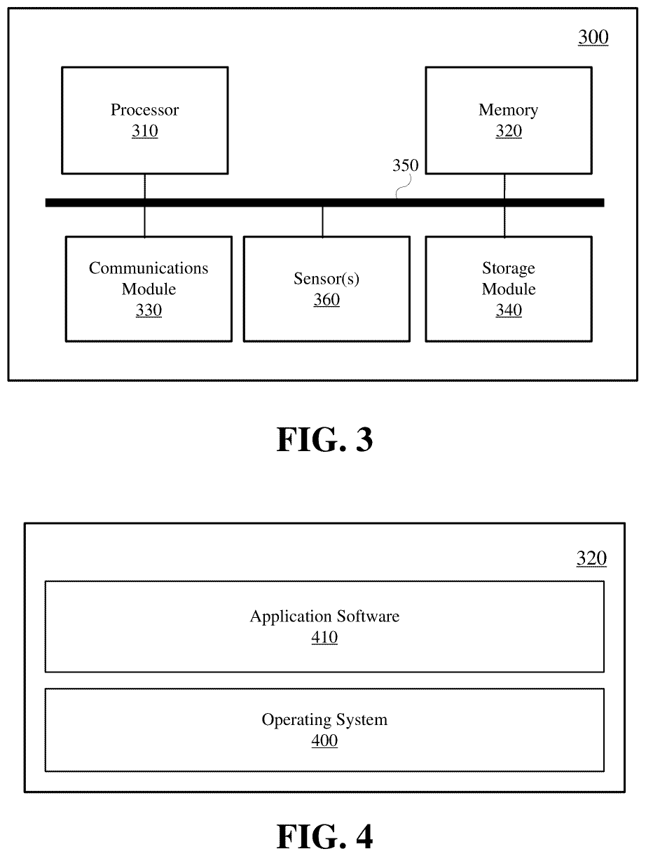

Referring now to FIG. 3, a high-level operation diagram of an example computer device 300 is shown. In some embodiments, the computer device 300 may be exemplary of one or more of the item access control system 100, the electronic device 130, the electronic device 280 the particular receptacle 170 and/or the identification server 210.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi (™), using Bluetooth (™) or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application. The communications module may, in various implementations, be one or more of: a communications device, a communications interface, a communications chip, and/or a transceiver.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persistent storage other than the persisted storage (if any) accessible via the memory 320. In some embodiments, the storage module 340 may be used to store and retrieve data in a database. A database may be stored in persistent storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access remotely stored data using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

When the computer device 300 is exemplary of the item access control system 100 or, in at least some implementations, the electronic device 130, the computer device may include one or more sensors 360. The one or more sensors 360 may be or include any one or more of the sensors described above with reference to FIG. 1.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google (™) Android (™), Apple (™) iOS (™), UNIX (™), Linux (™), Microsoft (™) Windows (™), Apple OSX (™) or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the item access control system 100, the identification server 210 and/or the electronic device 130.

While a single application 410 is illustrated in FIG. 4, in operation the memory 320 may include more than one application 410 and different applications 410 may perform different operations.

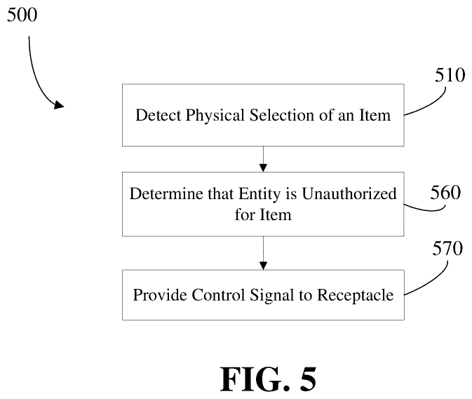

FIG. 5 is a flowchart showing operations performed by a system 200, such as the item access control system 100 (FIGS. 1 and 2), the particular receptacle 170 and/or the identification server 210 (FIG. 2). The operations may be included in a method 500 which may be performed by the item access control system 100 (FIGS. 1 and 2) and/or the particular receptacle 170 and/or the identification server 210 (FIG. 2). For example, computer-executable instructions stored in memory of the item access control system 100 (FIGS. 1 and 2) and/or the particular receptacle 170 and/or the identification server 210 (FIG. 2) may, when executed by one or more processors of the item access control system 100 (FIGS. 1 and 2), the particular receptacle 170 and/or the identification server 210 (FIG. 2), configure the item access control system 100 (FIGS. 1 and 2), the particular receptacle 170 and/or the identification server 210 (FIG. 2) to perform the method 500 or a portion thereof.

At operation 510, the method 500 includes detecting a physical selection of an item by an entity. The entity may be associated with a receptacle, such as the particular receptacle 170.

Physical selection of an item may be detected based on an output of a sensor. The sensor may be of the type described above; for example, with reference to FIG. 1. By way of example, in some implementations, the sensor may be or include a gaze detection sensor which identifies when the entity is looking at a particular item. Selection may be detected based on gaze. For example, when the entity is determined to be looking at a particular item, that item may be considered to be selected for the purposes of the method 500.

In some implementations, other techniques for identifying selection may also be used instead of or in addition to gaze detection. By way of example, in some implementations, selection of an item may be detected by detecting a dwell at a region associated with the item. For example, selection of the item may be determined to have occurred when a dwell of an entity is detected in a geofence for the item. A dwell may be detected, for example, when the entity has not substantially moved for at least a threshold period of time. The threshold period of time may be a period of time that suggests that the entity is browsing; that is, contemplating a purchase. In other implementations, the dwell may be detected if it is determined that the entity has remained in the geofence for the restricted item for at least a threshold period of time. By way of example, the geofence may be or include a particular aisle or region or a portion thereof within a premises. The geofence may be an area of the premises in which the item is located. In some instances, a dwell may be detected based on a sensor such as a camera 140a, 140b.

In some implementations, mere gazing or dwelling is not enough, in itself, to be considered a selection. Rather, the entity must perform a more positive action for the item to be determined to be selected. For example, in some implementations, selection may mean that the entity has performed a physical action with respect to the item.

In another example of a technique that may be used to identify selection of an item, the item access control system 100 may determine that an item has been selected when it detects that the entity has picked up the item. The picking up of an item may be detected using a sensor output of a camera 140a, 140b, for example.

In another example of a technique that may be used to detect selection of an item, the item access control system 100 may detect physical selection of the item when it determines that the item has been added to a particular receptacle 170 associated with the entity, such as a particular receptacle 170 in use by the entity. The item access control system 100 may identify that the restricted item has been added to the particular receptacle 170 based on the output of a sensor, such as a receptacle contents detector 146 and/or a camera 140a, 140b.

In another example of a technique that may be used to detect selection of an item, the item access control system 100 may identify selection of the item based on detected browsing activity of the entity with the item. By way of example, selection may be detected when the entity is determined to have examined a price tag for the item. By way of further example, selection may be detected when the entity is determined to have contacted (e.g., touched) the restricted item. These types of selection may be detected based on the output of a camera 140a, 140b.

At the operation 510, the system 200 performing the method 500, such as the item access control system 100, may determine that a particular item has been selected. This determination may trigger a subsequent operation, such as the operation 560. That is, an operation 560 may be performed in response to determining that the item has been selected. In some implementations, the operation 560 may be performed immediately and directly in response to determining that the item has been selected. In other implementations, some of which will be described in greater detail below with reference to other figures, both selection of the item and another condition must be determining to have occurred before the operation 560 is triggered. That is, the operation 560 may be triggered in response to a plurality of preconditions having occurred, one of which is the selection of the item.

At the operation 560, the system 200 performing the method 500, such as the item access control system 100, determines whether the entity is authorized to physically select the item. In the example of FIG. 5, the system determines, at the operation 560, that entity is not authorized to physically select the item. The determination regarding whether the entity is authorized to physically select the item may be may based on profile data. The profile data may be associated with one or both of the entity or the particular receptacle. For example, in some implementations, different entities may have different item access rights and the system 200 may determine whether the entity that has selected the item is permitted to do so. The access rights may be defined in or determined based on the profile data for the entity. For example, the profile data for the entity may indicate a parameter and access rights that define what items may or may not be selected may be determined based on that parameter. For example, the parameter may be or include any one or more of: a job associated with the entity, a role associated with the entity, a title associated with the entity, access rights associated with the entity, an age associated with the entity, an employer associated with the entity, or another characteristic of the entity. Put differently, the other parameter(s) may include one or more of a job identifier, a role identifier, a title identifier, an age identifier, an employer identifier, an access rights identifier or a characteristic identifier of another type. Put differently, the parameters that may be used to determine whether the item may be selected by the entity may include one or more of a job identifier, a role identifier, a title identifier, an age identifier, an employer identifier, an access rights identifier or a characteristic identifier of another type.

In some implementations, the profile data may be associated with the particular receptacle 170. For example, different receptacles may be associated with different access rights. For example, in some implementations, different types of receptacles may be used by different types of entities. For example, a plumber may use a certain type of receptacle and an electrician may use another type of receptacle and so the type of access rights may be determined based on the profile data for the receptacle itself.

In another example, the profile data may be associated with both the entity and the particular receptacle 170. For example, it may be that, when a particular entity has begun using a particular receptacle, the profile data for that entity may be stored in association with that particular receptacle. This may improve computing performance in some implementations since the profile data for an entity is effectively pre-loaded by being stored in association with the particular receptacle 170 when that particular receptacle 170 is enlisted for use by that entity. Then, when an item is added to that receptacle, the entity that added the item may not need to be identified. The system may determine whether the item was authorized to be added to the particular receptacle 170 based on the profile data that was already stored in association with the particular receptacle 170 for that entity.

Access rights as referred to herein may also be referred to as one or more of the following: selection rights, item access rights, item selection rights, authorization parameters, selection parameters, access parameters, item authorization parameters, item selection parameters, item access parameters, item restrictions, authorization restrictions, selection restrictions, access restrictions, item authorization restrictions, item selection restrictions, or item access restrictions.

When it is determined, at the operation 560, that the entity is not authorized to select the item that it has selected, a further operation 570 may be triggered. That is an operation 570 may be performed in response to determining that the entity is not authorized to physically select the item. The operation 570 may be performed directly and automatically by the system 200 in response to determining that the entity is not authorized to physically select the item. That is, no further conditions may be required to be detected or determined to have occurred in order to cause the operation 570 to be performed.

At the operation 570, the system 200 may provide a control signal to an electrical component associated with the receptacle to invite deselection of the item. The electrical component may be of a type described herein. The electrical component may be provided on the particular receptacle 170.

The electrical component may be of various types. For example, the electrical component may be an output device. An output device may include one or more of a display, a light, a speaker and/or an audible alarm. When an item access control system 100 determines that an unauthorized item has been selected, it may, at the operation 570, cause an output device on the receptacle to generate an output indicating that an unauthorized item has been selected. For example, when an item access control system 100 determines that an unauthorized item has been selected, it may, at the operation 570, cause the display or speaker to output a message indicating that the item should be removed. In some implementations, when an item access control system 100 determines that an unauthorized item has been selected, it may, at the operation 570, cause a speaker or alarm to generate an audible alarm. In some implementations, when an item access control system 100 determines that an unauthorized item has been selected and/or added to the particular receptacle 170, it may, at the operation 570, activate the light so that the light visually indicates that the particular receptacle is carrying an unauthorized item.

In some implementations, the electrical component that is controlled at the operation 570 may be or include a lockable feature. For example, the receptacle may be a cart that has a wheel associated with a lock. The item access control system 100 may in some implementations, include such a cart. When the item access control system 100 determines that an unauthorized item has been added to the particular receptacle 170, it may, at the operation 570, cause the lock to be engaged to prevent rotation of the wheel.

In another example, the particular receptacle 170 may have another type of electrical component that may be controlled to invite deselection of a selected item. For example, in one implementation, the control signal causes an output device on the receptacle to generate a signal that triggers a lock on an access control gate to prevent the receptacle from passing through the access control gate. For example, the particular receptacle may include a beacon that may be activated to emit a wireless signal that prevents the receptacle from travelling through a gate or access point. For example, the beacon may emit a non-audible signal to a reader associated with the gate or access point. When an unauthorized item has been added to the particular receptacle 170, the beacon may be controlled, at the operation 570, to emit a signal that instructs the gate or access point to remain closed to prevent the receptacle from travelling therethrough. For example, automatic doors may be prevented from opening when the receptacle is near such doors and includes an unauthorised item.

In another example, the beacon may cause an audible and/or visual alarm to be activated when the particular receptacle 170 containing the unauthorized item is brought near a location associated with the alarm. That is, when the beacon is controlled to emit a signal that indicates, to the alarm, that the receptacle has an unauthorized item, the alarm may be activated. In this way, at the operation 570, the electrical component may be controlled to configure the receptacle to trigger the alarm when it is brought near a location or when it attempts to pass through a particular access point, gate or system.

In a further example, the particular receptacle 170 may include an electrical component that inhibits or prevents easy movement of the particular receptacle 170. This electrical component may be, for example, a vibratory device and/or a steering inhibitor device. Such devices may be activated by the access control system 100 at the operation 570 in response to the determination that an unauthorized item has been selected. The vibratory device may cause the receptacle to vibrate or shake so that it is difficult or uncomfortable to steer or move or carry. A steering inhibitor device may prevent easy movement of the particular receptacle 170 when the receptacle has an unauthorized item. For example, a wheel may be turned to the side and, in at least some implementations, may be locked in such position to prevent easy steering.

In yet a further example, the particular receptacle 170 may include an electrical component that causes the particular receptacle 170 to move. This electrical component may, for example, include a drive unit. The drive unit may be controlled by the access control system 100 to either prevent movement of the receptacle or to automatically navigate the receptacle away from its user at the operation 570. The drive unit may include, for example, a motor. The motor may be locked when at unauthorized item has been selected or the motor may be activated to cause the receptacle to navigate to a particular location. For example, the receptacle may be moved to an area associated with a supervisor or manager. In some instances, the motor may be activated to move the receptacle away from the entity carrying the item. For example, the receptacle may keep moving away from the entity as the entity moves towards the receptacle, preventing the entity from adding the item to the receptacle. Such actions may cause the entity to return the item to the place from which it was selected out of frustration.

Variations of the method 500 of FIG. 5 are also contemplated. For example, the method 500 may be varied to include more or less operations than those indicated in FIG. 5.

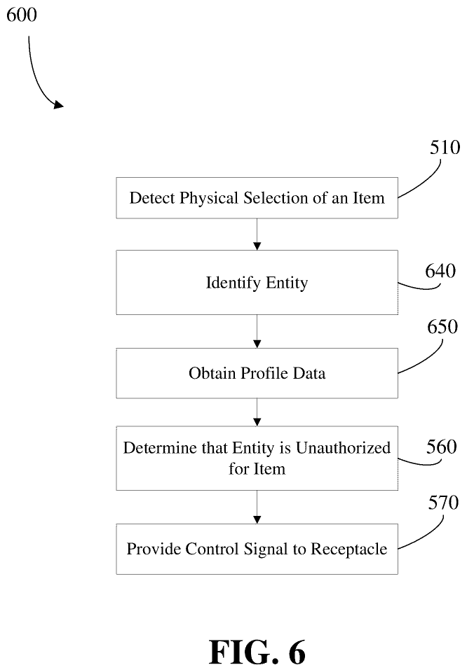

FIG. 6 illustrates a method 600 that is a variation of the method 500 of FIG. 5. FIG. 6 is a flowchart showing operations performed by a system 200, such as the item access control system 100 (FIGS. 1 and 2), particular receptacle 170 and/or the identification server 210 (FIG. 2). The operations may be included in a method 600 which may be performed by the item access control system 100 (FIGS. 1 and 2), particular receptacle 170 and/or the identification server 210 (FIG. 2). For example, computer-executable instructions stored in memory of the item access control system 100 (FIGS. 1 and 2) and/or the identification server 210 (FIG. 2) may, when executed by one or more processors of the item access control system 100 (FIGS. 1 and 2), particular receptacle 170 and/or the identification server 210 (FIG. 2), configure the item access control system 100 (FIGS. 1 and 2), particular receptacle 170 and/or the identification server 210 (FIG. 2) to perform the method 600 or a portion thereof.

The method 600 of FIG. 6 may include a number of operations in common with the method 500 of FIG. 5 and the description of such operations will not be repeated. For example, the operations 510, 560 and 570 are also included in the method 600 of FIG. 6. The method 600 indicates a possible technique of obtaining and using profile data.

The method 600 includes an operation 640 in which the system 200 performing the method identifies an entity. The entity may be identified based on an output of a sensor, such as a camera 140a, 140b. For example, facial recognition may be performed to identify an entity currently using a particular receptacle 170. Other techniques for identification are possible. For example, such techniques may use one or more of: a fingerprint, a credential (such as a username, password and/or PIN), a retina scan, scanning of a token such as an RFID tag, etc.

After the entity has been identified, profile data for that entity, or a portion thereof, may be obtained at an operation 650. The profile data may be retrieved from a datastore, which may include a database. The profile data may be uniquely associated with the identified entity.

The retrieved profile data may be stored in computer memory. In some implementations, the retrieved profile may be stored on memory in association with the particular receptacle. Such memory may, in some implementations, be on the particular receptacle itself.

After the profile data has been stored, it may be used at the operation 560 to determine whether the entity is authorized to select the item, as described above with reference to FIG. 5 and, if not, the control signal may be provided at the operation 570 as also described above. When the system 200 determines that the entity is not authorized to physically select the item, the system may then perform the operation 570 to provide the control signal to the receptacle, as described above with reference to the method 500 of FIG. 5.

While FIG. 6 illustrates the operations 640 and 650 as being performed after detection of a physical selection of an item at the operation 510, in some implementations, the operations 640 and 650 may be performed at other parts of the method 600 or prior to the method 600. For example, the operations 640 and 650 may be performed in response to determining that an entity has initiated an item-selection session; for example, in response to determining that the entity has initiated a new shopping session. A new shopping session or item-selection session may be determined by detecting that the entity has selected a particular receptacle 170 to use. By way of example, as soon as an entity selects a receptacle (e.g., by moving it or otherwise engaging with it), the system 200 may determine the identity of that entity and may associate the entity's profile with the particular receptacle. This may allow the particular receptacle to be controlled at the operation 570 based on actions performed by the entity.

In another example, the operations 640 and 650 may be performed in response to determining that the entity has entered the premises. For example, when a new entity enters the premises, they may be identified (at operation 640) and their profile data obtained (at operation 650).

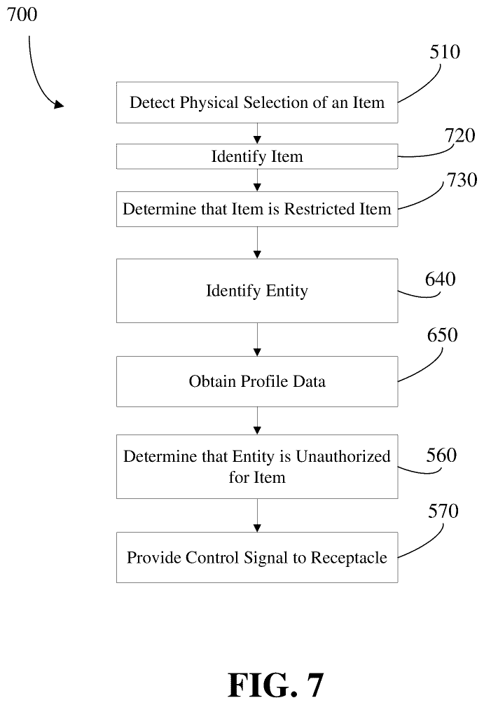

FIG. 7 illustrates a method 700 that is a variation of the method 500 of FIG. 5 and the method 600 of FIG. 6. FIG. 7 is a flowchart showing operations performed by a system 200, such as the item access control system 100 (FIGS. 1 and 2), particular receptacle 170 and/or the identification server 210 (FIG. 2). The operations may be included in a method 600 which may be performed by the item access control system 100 (FIGS. 1 and 2), particular receptacle 170 and/or the identification server 210 (FIG. 2). For example, computer-executable instructions stored in memory of the item access control system 100 (FIGS. 1 and 2) and/or the identification server 210 (FIG. 2) may, when executed by one or more processors of the item access control system 100 (FIGS. 1 and 2), particular receptacle 170 and/or the identification server 210 (FIG. 2), configure the item access control system 100 (FIGS. 1 and 2), particular receptacle 170 and/or the identification server 210 (FIG. 2) to perform the method 700 or a portion thereof.

The method 700 of FIG. 7 may include a number of operations in common with the method 500 of FIG. 5 and method 600 of FIG. 6 and the description of such operations will not be repeated. For example, the operations 510, 560 and 570 (of the methods 500 and 600 of FIGS. 5 and 6 ) and the operations 640, 650 (of the method 600 of FIG. 6) may also be included in the method 700 of FIG. 7. The method 700 indicates, among other things, a possible technique of identifying restrictions associated with a selected item.

In the method 700 of FIG. 7, the system 200 may, after performing the operation 510 in which the system detects physical selection of an item, perform an operation 720. The operation 720 may be performed in response to detecting physical selection of the item at the operation 510. At the operation 720, the system 200 may identify the item. That is, the system 200 may identify the item that was selected at the operation 510. The item may be identified based on an output of a sensor. The sensor may be of a type described herein. For example, it may be a camera 140a, 140b in some implementations.

The identification of the item may be performed using a database, such as the datastore 245, which may be an inventory tracking data store.

Once the item is identified, the system 200 may obtain one or more parameters associated with the item. Such parameters may be used at the operation 560 by the system 200 to determine whether the entity is authorized to select the item.

In the illustrated example, at an operation 730, the system 200 determines that the identified item is a restricted item.

A restricted item is an item of the type described above. By way of example, the restricted item may be an age restricted item. An age-restricted item is an item that is only available for purchase by purchasers satisfying defined age criteria. The age criteria may, for example, include a threshold. The threshold may be, for example, a minimum age required to purchase the age-restricted item. By way of example, the age-restricted item may be a tobacco item such as cigarettes or chewing tobacco, a lottery item such as a lottery ticket, 50/50 ticket or scratch ticket, an alcohol product such as beer, wine or spirits, or a cannabis product such as a smokeable cannabis product, edible cannabis product, or an oil.

In some implementations, it may be that the age-restriction for an item has a maximum age defined for purchase. Such a restriction may be implemented, for example, where the item is only available in limited quantities and the merchant associated with the premises wishes to restrict the item to a target demographic; such as children. Or, it may be that the item is a “junior” item which requires a customer to be under a particular age; e.g., under 18.

Restricted items may also be or include other types of restricted items, apart from age-restricted items. For example, a product may be restricted based on any one or more of: geographic location associated with a purchaser (e.g., to prevent purchasers who are not associated with a particular geographic region from making a purchase), an associated service or subscription (e.g., to only allow a purchase if a purchasing entity has a particular service or subscription such as a particular credit card, loyalty program, or subscription). By way of example, it may be that a promotion may only allow purchases to be made by customer that are members of a particular service, such as an automobile association. By way of further example, it may be that a product is restricted based on income; for example, the product may only be offered if a purchasing entity's income is less than a threshold.

Another example of restrictions are restrictions based on a job associated with the entity, a role associated with the entity, a title associated with the entity, access rights associated with the entity, an employer associated with the entity, or another characteristic of the entity. For example, in some implementations, only entities associated with certain jobs or roles may be permitted to select certain items.

In at least some implementations, the operation 730 and/or the operation 560 may be performed based on authorization data. For example, the system 200 performing the method 700 and/or a system associated with that system 200 may map one or more parameters to authorization data for one or more items. The authorization data may indicate whether entities with an associated parameter are permitted to select and/or otherwise engage with particular items. In some implementations, a parameter may be mapped to a category of items and the mapping may indicate that entities associated with the parameter are (or in the alternate case, are not) permitted to select and/or otherwise engage with items in that category.

In at least some implementations, the operation 730 and/or the operation 560 may be performed using machine learning. For example, a representation of the item, such as an image or video, may be passed to an artificial intelligence (AI) system and/or a machine learning system. This system may be configured to generate an output indicating whether the item is or is not restricted. In some instances, the system may be a large language model (LLM) system and it may receive a query. The query may be, for example, “Should there be any restrictions on the item depicted in this image?”. Other operations described herein may be performed in a similar manner. For example, in some instances, item categorization may be performed using AI and/or machine learning. By way of further example, in some instances, item identification may be performed using AI and/or machine learning. For example, an image may be passed to an LLM system together with a query such as “What is the item depicted in this photo?”

After the system 200 determines that the selected item has some restrictions associated with it, the system 200 may determine, at an operation 560, whether the entity, who may be identified at the operation 640 and whose profile data may be obtained at the operation 650, is authorized for that restricted item. For example, the system 200 may, at the operation 560, determine that the entity is not authorized to physically select the item by determining that the entity is not authorized for restricted items and/or for that specific restricted item.

When the system 200 determines that the entity is not authorized to physically select the item, the system may then perform the operation 570 to provide the control signal to the receptacle, as described above with reference to the method 500 of FIG. 5.

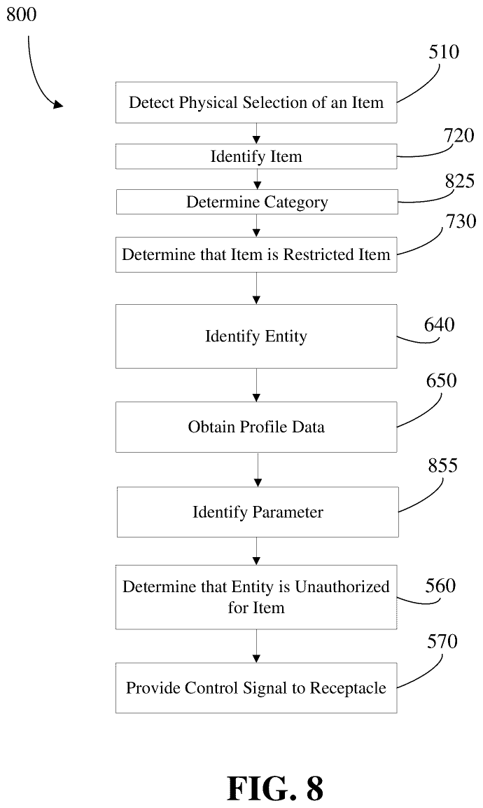

FIG. 8 illustrates a method 800 that is a variation of the method 500 of FIG. 5 and the method 600 of FIG. 6 and the method 700 of FIG. 7. FIG. 8 is a flowchart showing operations performed by a system 200, such as the item access control system 100 (FIGS. 1 and 2), particular receptacle 170 and/or the identification server 210 (FIG. 2). The operations may be included in a method 600 which may be performed by the item access control system 100 (FIGS. 1 and 2), particular receptacle 170 and/or the identification server 210 (FIG. 2). For example, computer-executable instructions stored in memory of the item access control system 100 (FIGS. 1 and 2) and/or the identification server 210 (FIG. 2) may, when executed by one or more processors of the item access control system 100 (FIGS. 1 and 2), particular receptacle 170 and/or the identification server 210 (FIG. 2), configure the item access control system 100 (FIGS. 1 and 2), particular receptacle 170 and/or the identification server 210 (FIG. 2) to perform the method 800 or a portion thereof.

The method 800 of FIG. 8 may include a number of operations in common with the method 500 of FIG. 5 and method 600 of FIG. 6 and the method 700 of FIG. 7 and the description of such operations will not be repeated. For example, the operations 510, 560 and 570 (of the methods 500 and 600 of FIGS. 5 and 6) and the operations 640, 650 (of the methods 600 and 700 of FIGS. 6 and 7) and the operation 720 and 730 (of the method 700 of FIG. 7) may also be included in the method 800 of FIG. 8. The method 800 indicates, among other things, a possible technique of using category data and using a parameter associated with an entity.

In the method 800 of FIG. 8, a category of an item physically selected at the operation 510 and identified at the operation 720 may be determined at an operation 825. This category may be used to determine whether the entity is authorized for the item at the operation 560. The category may be determined based on a class parameter stored in memory in association with the item. The category may represent a type of the item. By way of example, example categories may include any one or a combination of: consumer electronics, televisions, sporting goods, bicycles, financeable products, clothing, grocery items, etc. Other types of classes are possible, some of which are described in other parts of this document.

The system 200 may identify a parameter associated with the entity at the operation 855. The parameter may be identified from the profile data obtained at the operation 650 for the entity that was identified at the operation 640. The parameter may be one or more of: a job identifier, a role identifier, a title identifier, an age identifier, an employer identifier, an access rights identifier or a characteristic identifier of another type.

At the operation 560, the system 200 may determine that the entity is not authorized to physically select the item based on one or both of the category determined at the operation 825 and the parameter identified at the operation 855. For example, determining that the entity is not authorized to physically select the item may include determining that the entity is not authorized for accessing items having the identified category of the item. By way of further example, determining that the entity is not authorized to physically select the item may include determining, based on the parameter and the category of the item, that the entity is not authorized to physically select the item.

As in the previous methods 500, 600, 700, after the system 200 determines that the entity is not authorized to physically select the item, the system 200 may provide the control signal to the particular receptacle 170.

Optionally, the method 800 may include the operation 730 in which the system 200 evaluates whether the item is a restricted item.

Other variations of the methods described above are also contemplated.

Any examples involving a general purpose computer, aspects of this application transform the general-purpose computer into a special-purpose computing device when configured to execute the instructions described herein.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. An item access control system comprising:
a sensor;
a processor in communication with the sensor; and
a memory coupled to the processor, the memory storing processor-executable instructions which, when executed, cause the processor to:
detect, based on an output of the sensor, a physical selection of an item by an entity, the entity associated with a receptacle;
determine, based on profile data associated with one or both of the entity and the receptacle, that the entity is not authorized to physically select the item; and
in response to determining that the entity is not authorized to physically select the item, provide a control signal to an electrical component associated with the receptacle to invite deselection of the item.

2. The item access control system of claim 1, wherein the receptacle includes a cart having a wheel associated with a lock and wherein the control signal causes the lock to be engaged to prevent rotation of the wheel.

3. The item access control system of claim 1, further comprising:
the receptacle, and wherein the receptacle has a wheel associated with a lock.

4. The item access control system of claim 1, wherein the instructions further configure the processor to:
identify the entity based on an output of the sensor; and
obtain at least a portion of the profile data for the identified entity.

5. The item access control system of claim 1, wherein the instructions further configure the processor to:
identify the item based on an output of the sensor; and
determine that the identified item is a restricted item using a machine learning system, and wherein determining that the entity is not authorized to physically select the item includes determining that the entity is not authorized for restricted items.

6. The item access control system of claim 1, wherein the instructions further configure the processor to:
identify the item based on an output of the sensor; and
identify a category of the item,
and wherein determining that the entity is not authorized to physically select the item includes determining that the entity is not authorized for accessing items having the identified category of the item.

7. The item access control system of claim 6, wherein the instructions further configure the processor to:
identify a parameter associated with the entity from the profile data, and
wherein determining that the entity is not authorized to physically select the item includes determining, based on the parameter and the category of the item, that the entity is not authorized to physically select the item.

8. The item access control system of claim 7, wherein the parameter is one or more of:
a role identifier; and
an age identifier.

9. The item access control system of claim 1, wherein the control signal causes an output device on the receptacle to generate an output indicating that an unauthorized item has been selected.

10. The item access control system of claim 9, wherein the output device includes one or more of:
a light;
an audible alarm; and
a display.

11. The item access control system of claim 1, wherein the control signal causes an output device on the receptacle to generate a signal that triggers a lock on an access control gate to prevent the receptacle from passing through the access control gate.

12. The item access control system of claim 1, wherein detecting, based on an output of the sensor, a physical selection of an item by an entity includes determining that the item has been added to the receptacle based on the output of the sensor.

13. A method for controlling access to items, comprising:
detecting, based on an output of a sensor, a physical selection of an item by an entity, the entity associated with a receptacle;
determining, based on profile data associated with one or both of the entity and the receptacle, that the entity is not authorized to physically select the item; and
in response to determining that the entity is not authorized to physically select the item, providing a control signal to an electrical component associated with the receptacle to invite deselection of the item.

14. The method of claim 13, wherein the receptacle includes a cart having a wheel associated with a lock, and wherein the control signal causes the lock to be engaged to prevent rotation of the wheel.

15. The method of claim 13, further comprising:
identifying the entity based on an output of the sensor; and
obtaining at least a portion of the profile data for the identified entity.

16. The method of claim 13, further comprising:
identifying the item based on an output of the sensor; and
determining that the identified item is a restricted item using a machine learning system,
and wherein determining that the entity is not authorized to physically select the item includes determining that the entity is not authorized for restricted items.

17. The method of claim 13, further comprising:
identifying the item based on an output of the sensor; and
identifying a category of the item,
and wherein determining that the entity is not authorized to physically select the item includes determining that the entity is not authorized for accessing items having the identified category of the item.

18. The method of claim 17, further comprising:
identifying a parameter associated with the entity from the profile data, and
wherein determining that the entity is not authorized to physically select the item includes determining, based on the parameter and the category of the item, that the entity is not authorized to physically select the item.

19. The method of claim 18, wherein the parameter is one or more of:
a role identifier; and
an age identifier.

20. The method of claim 13, wherein the control signal causes an output device on the receptacle to generate an output indicating that an unauthorized item has been selected.
